(19) United States
(12) Patent Application Publication
(10) Pub. No.: US 2014/0304071 A1
(43) Pub. Date: Oct. 9, 2014

(54) SYSTEMS AND METHODS FOR PRESENTING ADVERTISEMENTS WITH SOFTWARE APPLICATIONS

(71) Applicant: Bunndle, Inc., Palo Alto, CA (US)

(72) Inventors: Maxine Manafy, Palo Alto, CA (US); Eddy Luten, Los Gatos, CA (US)

(21) Appl. No.: 13/934,182

(22) Filed: Jul. 2, 2013

Related U.S. Application Data
(60) Provisional application No. 61/810,169, filed on Apr. 9, 2013.

(51) Int. Cl. G06Q 30/02; H04W 4/00

(52) U.S. Cl. CPC G06Q 30/0255; H04W 4/003
USPC 705/14.53

(57) ABSTRACT

Exemplary embodiments of the present disclosure utilize identifiable information regarding hardware and/or software components of a client computing device to identify advertisements the end user of the client computing device is likely to find relevant and of interest. A computer-implemented method according to one exemplary embodiment of the present disclosure comprises receiving, by a computer system, information regarding a client computing device; accessing a database in communication with the computer system, the database storing a plurality of advertisements promoting a respective plurality of software applications; selecting, from the database, an advertisement from the plurality of advertisements based on the received information regarding the client device; and providing the selected advertisement to the client computing device for display using an advertising management software application operating on the client device.

### CROSS-REFERENCE TO RELATED APPLICATION

This application claims priority to U.S. Provisional Patent Application No. 61/810,169, filed Apr. 9, 2013 and entitled “SYSTEMS AND METHODS FOR PRESENTING ADVERTISEMENTS WITH SOFTWARE APPLICATIONS,” the content of which is incorporated by reference in its entirety.

### BACKGROUND

Exemplary embodiments described herein relate to systems and methods for presenting advertisements, and more particularly to dynamically presenting advertisements in conjunction with software applications.

As the popularity of software used on personal computers and mobile devices increases, the number of software applications available to end users has likewise increased. An unfortunate side effect of this rapid pace of software development is that many end users may be overwhelmed by the number of applications available, and, as a result, may not identify and download software applications they would otherwise value.

Developers of such applications typically use traditional advertising methods to promote their applications to end users, but such methods have limited abilities to target specific groups of users, and often fall short in being able to target the end users most likely to be interested in a given application. For example, the constraints on application promotion through web and mobile search services and mobile application stores (“app stores”) often results in a very low success rate reaching users interested in downloading an application developer's software. To compound this problem, end users often have a difficult time finding applications they are interested in, with many users basing their choice of applications not on the applications(s) most suited to their devices or interests, but on the top app listings in the app stores or recommendations from friends.

Most conventional advertising methods that attempt to target a specific audience perform such targeting based on demographic information such as gender, age, etc. Traditional demographic information, however, often provides limited results in targeting users for web and software applications. Some developers opt to list their software applications in an application store or on an aggregator site (i.e., listing service) and hope to achieve a high ranking in the list. With a high ranking, users may search for an application and click on a listing at the top, assuming that the application has been validated by others. Although some of the applications listed in these app stores are useful for the end user, these rankings may be susceptible to influence and manipulation by app stores or developers trying to get users to discover their applications through incentives. Embodiments of the present disclosure address these and other issues.

### SUMMARY OF THE DESCRIPTION

Exemplary embodiments of the present disclosure utilize identifiable information regarding hardware and/or software components of a client computing device to identify advertisements the end user of the client computing device is likely to find relevant and of interest. In this manner, embodiments of the present disclosure help advertisers to better target end users and limit advertisements to which end users are unlikely to respond, thereby providing a higher rate of success over conventional advertising methods.

A computer-implemented method according to one exemplary embodiment of the present disclosure comprises receiving, by a computer system, information regarding a client computing device; accessing a database in communication with the computer system, the database storing a plurality of advertisements promoting a respective plurality of software applications; selecting, from the database, an advertisement from the plurality of advertisements based on the received information regarding the client device; and providing the selected advertisement to the client computing device for display using an advertising management software application operating on the client device.

The present disclosure includes methods and apparatuses which perform these methods, including data processing systems which perform these methods, and computer readable media containing instructions which when executed on data processing systems cause the systems to perform these methods.

Other features will be apparent from the accompanying drawings and from the detailed description which follows.

### BRIEF DESCRIPTION OF THE DRAWINGS

A more complete understanding of certain embodiments may be derived by referring to the detailed description and claims when considered in connection with the following illustrative figures.

FIG. 1 is a flow diagram showing an exemplary process according to various embodiments.

FIG. 2 is a flow diagram showing another exemplary process according to various embodiments.

FIG. 3 is a block diagram of an exemplary system according to various embodiments.

FIGS. 4-6 are exemplary screenshots according to various embodiments.

### DETAILED DESCRIPTION

Embodiments of the present disclosure help enable advertisers to display advertisements (also referred to herein as “offers” or “promotions”) in, or in conjunction with, various software applications running on a target machine (also referred to herein as “the user's machine,” “target device,” “client computing device,” or “client device”). In some embodiments, publishers of a software application may include an advertising space (also referred to herein as an “Ad Window”) to show users particular ads within the application. Embodiments of the present disclosure may operate in conjunction with Ad Windows of any size, shape and configuration. Advertisements (also referred to herein as “offers”) may be displayed in the Ad Window from any desired source, such as from a server having a database of advertisements in communication with the computing device upon which the application displaying the Ad Window runs.

In the detailed description herein, references to “various embodiments”, “one embodiment”, “an embodiment”, “an exemplary embodiment”, etc., indicate that the embodiment described may include a particular feature, structure, or characteristic, but every embodiment may not necessarily include the particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described.

For the sake of brevity, conventional data networking, application development and other functional aspects of the systems (and components of the individual operating components of the systems) may not be described in detail herein. Furthermore, the connecting lines shown in the various figures contained herein are intended to represent exemplary functional relationships and/or physical couplings between the various elements. It should be noted that many alternative or additional functional relationships or physical connections may be present in a practical system.

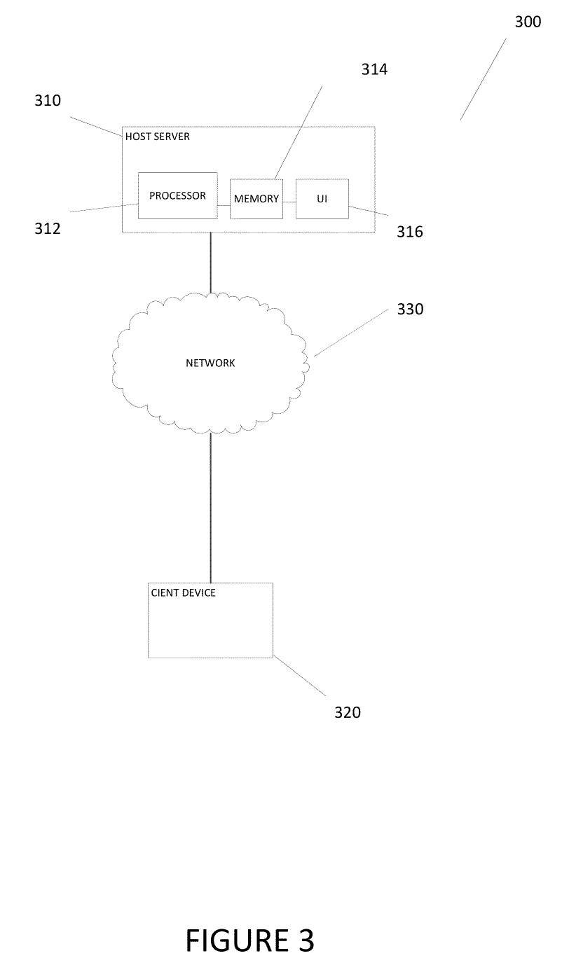

Any combination and/or subset of the elements of the methods depicted herein may be practiced in any suitable order and in conjunction with any suitable system, device, and/or process. The methods described and depicted herein can be implemented in any suitable manner, such as through software operating on one or more computer systems, including host system 310 depicted in FIG. 3. Such software may comprise computer-readable instructions stored in a tangible computer-readable medium (such as the memory 314 of host computer system 310) and can be executed by one or more processors (such as processor 312 of host computer system 310) to perform the methods of various embodiments.

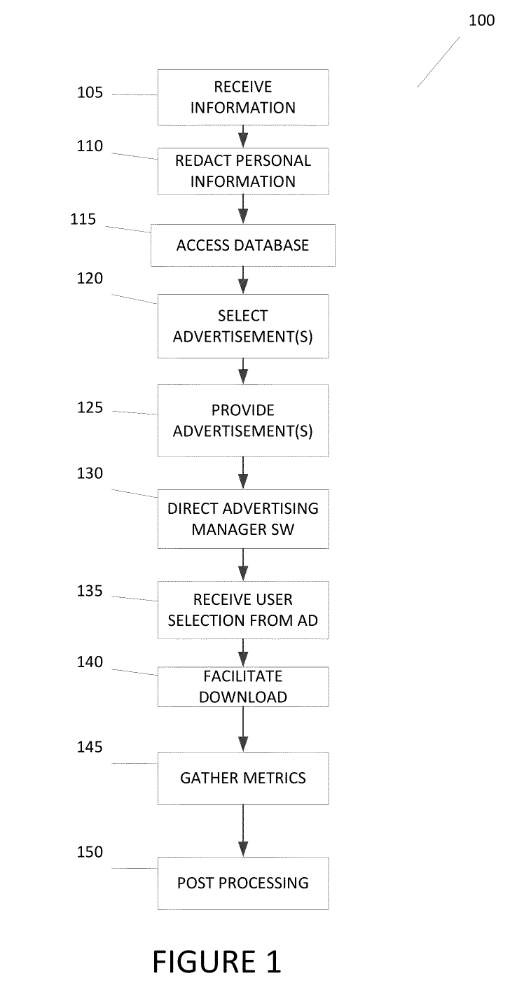

FIG. 1 depicts an exemplary process according to various embodiments of the present disclosure. In FIG. 1, method 100 includes receiving information regarding a client computing device (105), redacting personal information from the received information (110), accessing a database storing advertisements (115), selecting one or more advertisements (120), providing one or more advertisements to the client computing device for display (125), and directing advertisement management software operating on the client device (130). The method 100 further includes receiving a user selection from a provided advertisement (135), facilitating download of a software application promoted by an advertisement (140), gathering metrics (145), and post processing (150).

Information regarding a client computing device may be received (105) from any source and in any desired manner. In one exemplary embodiment, a software application (which may be referred to herein as the “Offer Manager”) operating on a target client computing device (such as client device 320 in FIG. 3) provides information regarding the device to a server, such as host server 310 in FIG. 3. The Offer Manager may communicate with the server (e.g., by sending an HTTP request to a backend service) to provide various information about the target machine to help determine what offers, advertisements, or other promotions are to be displayed. Information regarding a client computing device may also be received from other types of software applications or other sources, such as a database storing information regarding the target client device.

Embodiments of the present disclosure may analyze a variety of information regarding a client device, such as: registry information; operating system information; information regarding a file stored on the client device; a name of a software application installed on the client device; a version of a software application installed on the client device; a date when a software application was installed on the client device; a date when a software application installed on the client device was last used; a name of a software application currently in operation on the client device; a version of a software application currently in operation on the client device; information regarding access rights of a user of the client device; location information for the client device; information regarding a hardware component of the client device; information regarding resources of the client device; and/or other information.

Among other things, embodiments of the present disclosure allow advertisements to be optimized and targeted to particular audiences. Advertisements may be selected and displayed based on information regarding the hardware of a computing device, a user of the computing device, software applications installed on the computing device, as well as other information. Different combinations of such information may be analyzed based on, for example, different types of applications being advertised as well as based on other factors.

To protect the privacy of users, embodiments of the present disclosure can target advertisements to users of client devices based on non-personally identifiable information, such as the settings on a user's computing device. For example, an advertisement can be targeted based on an application or other software that the user has on a machine (e.g., a particular web browser or operating system). An ad server and a client can operate in conjunction with a server to make the calls dynamically to show an advertisement based on targeting criteria. Referring again to FIG. 1, method 100 includes redacting (i.e., removing or deleting) any personal information (110) associated with the identity of a user of the client device that may be received. Such personal information may be associated with browser cookies, names of files residing on the client device, computer hardware names (e.g., “Joe Smith's Laptop”), and other hardware and software components on the client device. In one embodiment, the received information is analyzed to identify any such personal information, and such information is removed from the received data before further processing.

Embodiments of the present disclosure may access one or more databases (115) storing advertisements for display on the client device. Such databases may be maintained by any entity, such as a publisher of a software application being promoted by such advertisements, or another entity. Such databases may be integrated with other systems, devices, servers or other components, such as host server 310 in FIG. 3. Alternatively, various portions or components of an advertising database may be located at a single location or at multiple locations, and may include a variety of security features, such as firewalls, access codes, encryption, decryption, compression, decompression, and/or the like. A database operating in conjunction with embodiments of the present disclosure may be accessed in any suitable manner, including via a network, such as network 330 in FIG. 3.

Such databases may have a relational, hierarchical, graphical, object-oriented, and/or other structure or configuration. Such databases may include data tables, lookup tables, or other data structures. Advertisements may be stored in individual records or as a collection of records, and each record may be a single file, a series of files, a linked series of data fields or have any other suitable data structure. Association of certain data may be accomplished through any desired data association technique, and such associations may be accomplished either manually or automatically.

Embodiments of the present disclosure may access one or more databases based on any desired criteria, such as one or more fees offered by a host of an advertising database for displaying the host's advertisements, a determined level of popularity for a software application advertised by a particular entity, and other criteria. In one embodiment, the information received regarding the client device is analyzed and an advertising database selected for access based on the analysis.

Based at least in part on the information regarding the client device, one or more advertisements are selected (120) and provided to the client device for display (125). In one embodiment, the backend service may send a collection of offers that meet defined criteria to the client computing device for the advertising management software (“Offer Manager”) to display. The criteria can be defined in any suitable manner, such as based on explicit directives from one or more entities (for example, the advertiser and/or a provider of the Offer Manager) as well as based on criteria generated automatically based on an analysis of historical viewing and installation metrics.

Software implementing various functionality of the present disclosure may analyze the information regarding the client device in any desired manner to identify one or more advertisements to display on the client device. In one exemplary embodiment, each offer stored in the advertisement database may include a set of specific criteria to be used in analyzing the received information for the client device. In some cases, the advertisement may have custom code (e.g., in Javascript) that can be downloaded to the Offer Manager or run against the received information to perform the specific checks against the target machine. Such checks may include, for example, registry key checks, checking if a file exists, the name and/or version of a web browser or other software application, the access rights of the user of the target computing device (e.g., to determine if the user has administrator rights to install an application), as well as other checks.

Based on the result(s) of the various checks, offers that are consistent with the checks may be displayed. For example, embodiments of the disclosure may select an advertisement promoting a software application that, based on the received information regarding the client device, is capable of operating on the client device, and exclude an advertisement promoting a software application that cannot run on the client device. As discussed in more detail below, various advertisements can be selected or excluded based on a variety of other criteria as well. In this manner, embodiments of the present disclosure can help ensure that advertisements likely to be of interest to a user are displayed, while excluding (or minimizing the display of) advertisements that are unlikely to be of interest to the user.

Advertisements may be selected for display on the client device based on the format and/or content of an ad, as well as based on the capabilities (e.g., determined from the information received regarding a client device) of the client device to display the advertisement. Additionally, embodiments of the present disclosure may reformat an advertisement to allow it to be suitably displayed on the client device. For example, if an advertisement includes video or graphics that are beyond the capabilities of the device to display, or an image that is of too high a size or resolution for the display of the client device, embodiments of the disclosure may exclude the advertisement from being provided to the client device, select another advertisement for the same software application that could be displayed on the device, or reformat the advertisement so that it could be viewed on the client device. In some embodiments, software operating on a server (such as host server 310 in FIG. 3) may query software operating on a client device (such as the Offer Manager operating on client device 320 in FIG. 3) for the content format(s) the Offer Manager or client device is capable of displaying prior to providing one or more advertisements.

In some embodiments of the present disclosure, selecting an advertisement includes determining, based on the received information regarding a client device, recommendation values for one or more software applications promoted by one or more respective advertisements. The recommendation values can be compared to each other to help select an optimal advertisement to provide to the client device.

The recommendation value assigned to a software application may be determined based on any desired criteria, such as the similarity between the application being advertised and applications that have been successfully cross-promoted in the past (i.e., where advertisements have resulted in an installation). Embodiments of the present disclosure may determine recommendation values for specific client devices or for groups of client devices. Additionally, recommendation values can be recalculated as desired, such as when the characteristics of the software change over time.

In some exemplary embodiments, a recommendation value may be determined based on one or more characteristics, such as a category to which one or more applications are classified, a price of one or more software applications, and/or a size of one or more software applications. A recommendation value may be determined based on any number of other characteristics for a software application (or otherwise), such as one or more capabilities of an application, a publisher of an application, one or more platforms with which the application is compatible, a date/time an application was installed or updated, and others.

Additional characteristics that may be used in determining a recommendation value include: information on a client device's network connectivity and capabilities, such as Wi-fi, Bluetooth, and the like; global positioning system (GPS) or location-determination capability (e.g., whether GPS is enabled or disabled, and whether or not the client devices is using a GPS chip or triangulation); system information for the client device, such as the manufacturer, model, brand, operating system version, processor, memory capabilities, and user interface features (e.g. screen resolution/size and graphics card capabilities); configuration information, such as language, country, and display name; peripheral devices connected to the client device; and any other retrievable information pertaining to the client device.

A recommendation value may also be determined based on any number of different software applications, such as an application installed on a client device, an application currently operating (i.e., running, not simply installed) on a client device, a software application being advertised for download, and/or a software application being cross-promoted in conjunction with a another application. In some embodiments, characteristics of software installed and/or operating on a client device may be analyzed to identify a degree of similarity between the existing applications and an application promoted by an advertisement, thereby helping to determine whether presenting the advertisement is likely to be of interest to the user of the client device. Additionally, embodiments of the present disclosure may be configured to give greater weight to an application that is currently in use (or frequently used) on the client device, over one that is installed on the client device but rarely used, in identifying the application's propensity to indicate a user's preference for a future application to download.

In one exemplary embodiment, an initial recommendation value for an application promoted by an advertisement is based on three application characteristics: one or more categories associated with the application, the price of the application, and the file size of the application. Values for each of the three characteristics are determined and ranked, and an advertisement corresponding to an application that would be best suited for cross-promotion or advertisement to an end user is selected, with the goal being that the end user would find the advertisement relevant and install the advertised application.

Software applications may be associated with any number of different categories and subcategories. For example, a spreadsheet application may be simultaneously associated with a “financial software” category and a “general office software” category, as well as one or more subcategories under each. In one exemplary embodiment, the value for the category characteristic is determined based at least partially on a number of installations of a software application and a number of views of the advertisement promoting the software application. For example, the “category value” (C in the equation below), may be determined as the ratio of the number of installations to the number of views.

Recommendation values based on different categories, such as the rate of installations to advertisement views, may provide valuable information to publishers and advertisers alike. For example, exemplary embodiments of the present disclosure can automatically determine category values based on different combinations of categories and provide a report in real-time or near-real-time to publishers, advertisers, or other entities to allow such entities to quickly identify correlations between different types of software. This can help publishers and advertisers more effectively bundle software applications together, as well as to cross-promote a software application in a category found to be highly correlated to the category of another application being purchased or downloaded by an end user.

Values for the price and size characteristics of software applications may be calculated based on the differences between two or more applications. For example, the file size and/or price of a software application promoted by an advertisement may be compared to the file size and/or price of a software application that is: installed on a client device, currently operating on the client device, and/or cross-promoted with the advertised application. Based on the difference in file size and/or price, a determination can be made whether the advertised application is likely to be of interest to the end user.

The “price variable”, P, in the present example is based on the difference between the prices of one or more software applications. “Paid applications,” or those applications which are not free and require the end user to purchase them for a fee, are also called “Premium Applications.” Users who are comfortable spending a set amount, say $1.99, for an application may be more likely pay another application of the same price. However, if the difference in the price of the applications is more significant, an end user may be less likely to pay for higher priced application(s). In some cases, accordingly, the smaller the difference (delta) between the price of the premium version of each application, the higher chance the end user will pay for the advertised application.

For example, if multiple software applications currently running on the client device are free (i.e., no cost) and under five megabytes in size, the recommendation value for an application that costs $50 and is over 50 megabytes in size may be determined to be lower than an advertised application that is $1.99 and is two megabytes.

The “size variable”, S, in the present example depends on the difference between the file size (in kb, Mb, Gb, etc.) of one or more software applications. If an end user has downloaded a first application of a certain file size successfully, this may be indicative that downloading an advertised application of the same or similar file size is acceptable to the end user.

In relation to the file size of an application, downloading a software application requires a certain amount of network connectivity, connection speed, and bandwidth. Device services and types differ in connection speed, and the location of the end user may also greatly affect the ability to download files, particularly ones that are large. Accordingly, while not detailed in this example, network resources and the location of the computing device are characteristics that may also be quantitatively evaluated as part of a recommendation score.

For example, if the end user has previously downloaded an application that is large in size, it may be determined that the user will be able to successfully download an advertised program that is of the same size or smaller. If, on the other hand, the advertised application is greater in size, the size differential may be indicative that the user may not wish to download the larger application.

Continuing with the present example, once the above three variables, C, P and S, are determined for an advertised application, the Recommended Value, R, can be calculated as:

R=aC+bP+cS
Where:
R=Recommended Value;
C=Category Matching Value;
P=Price Delta Value;
S=Size Delta Value;
a=Category Matching Coefficient;
b=Price Coefficient; and
c=File Size Coefficient.

The values of a, b, and c are constants and may change over time depending on the total number of applications in the system and the relative performance measured across all installations. The recommendation value, R, may be R used to determine which advertisement to select for display to the end user of a client device.

Embodiments of the present disclosure can be used to provide ads, offers, and other promotions for display (125) in conjunction with any type of software application, including applications run on a computing device (such as a personal computer, laptop, mobile device, and the like). Additionally, embodiments disclosed herein may be used to serve targeted ads on websites.

In some embodiments, collection of the information regarding a client device and display of advertisements is handled, at least in part, by the Offer Manager. The Offer Manager may include any number of different processes and components and may be configured to operate on any number of different hardware platforms and with a variety of different operating systems. In one exemplary embodiment, the Offer Manager is a distributable software component for the Windows XP Service Pack 2 Operating System (and higher) and includes three components: a Client, an Agent, and a Process Host, described in more detail below.

Once an instance of the Offer Manager is created, multiple windows can be registered for the purpose of displaying offers. When registering a window, a placement globally unique identifier (GUID) is provided so that offers can be downloaded and evaluated. Multiple windows can share the same placement GUID if so required, these windows will then also share the cache of offers associated with the placement GUID.

Various functionality of the Offer Manager or other software controlling the display of advertisements can be directed (130) by, for example, software operating on a server (such as host server 310 in FIG. 3) that also provides the advertisements to the client device. For example, the Offer Manager may be directed to display an advertisement for a predetermined duration, as well as to control the frequency with which the advertisement is displayed. Alternatively, control of the duration and frequency of advertisement display may be determined by the Offer Manager or other software displaying the advertisements.

Offers can be displayed for a predetermined duration before another offer is displayed. In one embodiment, multiple offers may be provided to a client device and each offer may be displayed for a predetermined period of time (e.g., 15 minutes for each window) after which time another advertisement replaces the previous advertisement. Advertisements may be displayed for different periods of times and at different frequencies based on any desired criteria, including the recommendation value associated with each respective advertisement or product promoted therein. Groups of advertisements may be replaced after a predetermined period of time as well. In one embodiment, a cache of advertisements is invalidated every hour.

In an exemplary embodiment where the Offer Manager includes a Client, an Agent, and a Process Host, the client may be configured to relay commands from a software application (also referred to as a “publisher's application”) to the Offer Manager, implementing the BunndleInAppOfferManager COM interface. In some embodiments, the Client may be designed as a lightweight component with limited functionality to allow for the updating of the logic in the other components without asking the publisher to re-integrate. In one exemplary embodiment, the client performs the fetch-agent step; launches the agent's process host; and relays commands to the agent, as described in more detail below.

Before the fetch agent runs, the client checks if there is an updated version of the Offer Manager DLL available through a web service referred to as “Fetch-Agent.” If an updated DLL is available, it is downloaded and placed on the user's computing device and the process host is used to instantiate it.

The process host may be implemented as a small executable contained within the Offer Manager DLL that hosts the agent instance shared between all of the clients. Additionally, the Process Host may be responsible for the deletion of the temporary directory used by the Offer Manager agent. In one embodiment, the process host is launched by the client after the agent is unpacked and has the following command line arguments:

iaomphost.exe path_to_agent[--noCleanup]

In this example, “--noCleanup” is a flag that, if supplied, causes the temporary directory to stay behind on the user's machine for debugging purposes.

While the task of hosting the DLL may be performed by a built-in Windows executable (such as rundll32.exe), the rundll32.exe this process has been deprecated as of Windows Vista and therefore cannot be used reliably. The iaomphost.exe executable allows the DLL to be hosted reliably and allows the provider of the Offer Manager to have more control over the process.

The Agent provides logic concerning serving offers, managing windows, installations, process and installer monitoring and other functions. In the present exemplary embodiment, the Agent handles most or all of the major functionality that may require updating in the future.

Once the Agent is instantiated it registers itself within the ROT (Running Object Table) so that it can be queried by any program that requires it. The client queries the ROT in a timed loop and stores a handle to the agent once it becomes instantiated. The Agent maintains an internal list of subscribing publisher processes that it monitors so that it will not terminate abruptly. The Agent handles at least the following high level tasks: downloading offers for display; installing offers; running criteria checks; monitoring the Internet connection; and managing registered windows.

In one embodiment, the Agent process is independent from the client process that initially spawned it so that it can remain active indefinitely to monitor installer processes and other client processes that may use the agent instance. Once all the installer and publisher processes have exited, the agent can exit as well.

Once a window is registered with the agent, various options can be set for that window, including: defining a path to the default/house offer to be shown in absence of offers or Internet connectivity; defining the action URL associated with the default offer shown; and defining the background color used to clear any portion of the offer window not covered by the offer. Embodiments of the present disclosure may allow advertising windows to be configured in any desired manner.

Once the window is enabled, offers are rendered inside of it. Internally, the Offer Manager agent may create a new child window that is displayed within the registered window. This child window renders the offer and produces window events that are handled by the Offer Manager agent. Each time an offer is shown, an impression report may be sent to the web service.

Embodiments of the present disclosure may support any type of advertising content. In one exemplary embodiment, the Offer Manager can support a variety of static image formats, including BMP, GIF (including animated GIF format), JPEG, PNG, TIFF, and EMF. The Offer Manager may also support video content, text, and other content.

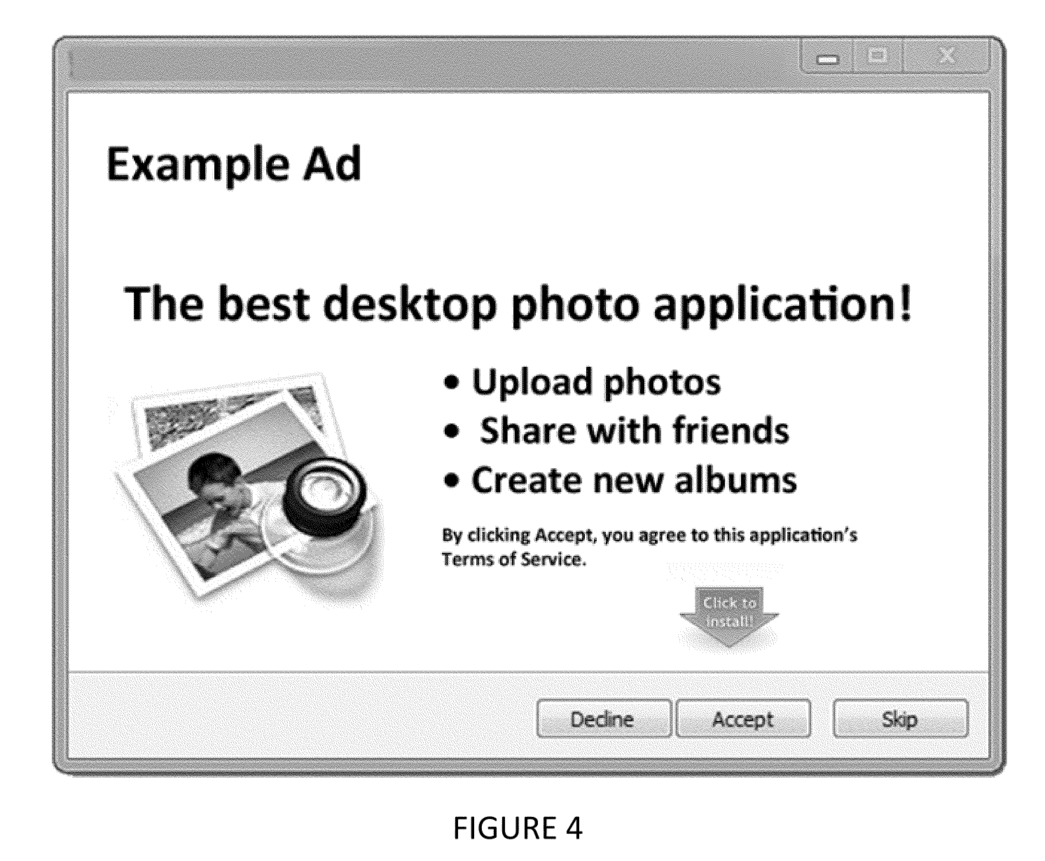

FIGS. 4-6 illustrate exemplary advertising content that may be displayed in conjunction with embodiments of the present disclosure. FIG. 4 is an example advertisement offer screen inside of an installer flow. In this example, the user clicks either the “Accept” or “Decline” button to accept or decline the installation of the advertisement. If the user clicks “Accept”, the Bunndle Offer Manager triggers the installation of the advertiser's installer product. The advertisement offer screen can vary in size. For example, this advertisement would be shown in dimensions of 500 pixels (width) by 300 pixels (height).

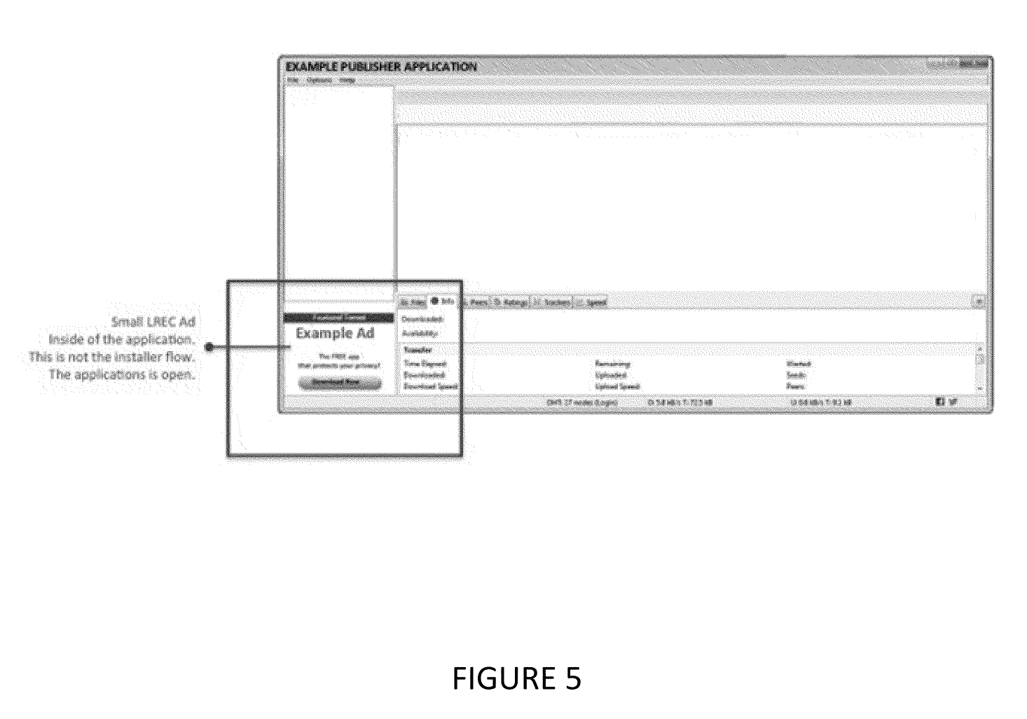

FIG. 5 depicts an example of an advertisement offer screen inside of the publisher's client product (open and in use). In this example, the user clicks on the advertisement and the installation of the advertiser's product is triggered using the Bunndle Offer Manager. The advertisement may vary in size. Here, the example shows a simple 118 pixels (width) by 82 pixels (height). The location of the advertisement may also vary. Here, the advertisement is shown in the lower left corner of the application, but it could also be displayed in any of the open available panels as designated by the publisher.

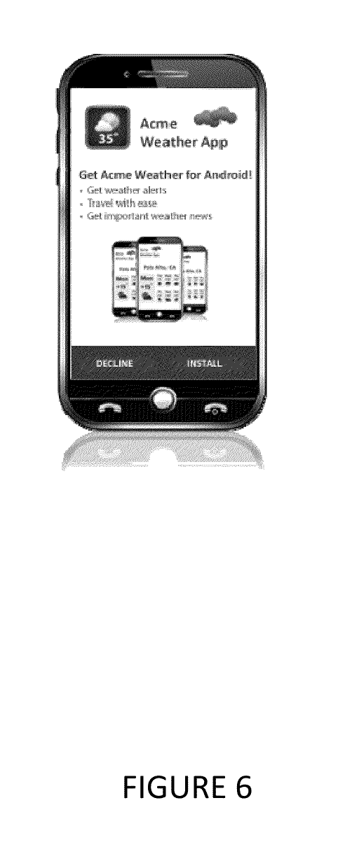

FIG. 6 depicts an example of an advertisement offer screen inside of a publisher's mobile application on a cell phone device. In this example, the user clicks either the “Install” or “Decline” button to accept or decline the installation of the advertisement. If the user clicks “Install,” the end user is directed to the application store front where the download of the advertiser's application is completed. The size of this advertisement may vary. FIG. 6 shows an exemplary full, interstitial advertisement, which may be shown after a call-to-action (i.e., a click to a button, a transition session the publisher's application, etc.) which triggers the advertisement. The advertisement could also be shown within the application side-by-side to the publisher's application, or as a smaller banner advertisement which is usually placed on top or at the bottom of the application screen.

When a user selects a portion of the offer (e.g., by clicking a “download” button in the offer or clicking on the offer itself), an indication of the selection is received (135) from the client device (e.g., from the Offer Manager) by the server implementing the web service, and download/installation of the software application associated with the offer is facilitated (140). Facilitation of the download may include, for example, redirecting the user to a website to download the software, or initiating a download of the software from a host server communicating with the Offer Manager. Various communications may also be received from the client device by the web service indicating the start of the installation, as well as upon the completion or failure of installation.

At any point during the end user's interaction with the advertisement, metrics and information may be received from the client device (145). For example, the contents of an in-memory log stored on the client device can be sent to the web service upon download of the application promoted by advertisement, or upon expiration of the advertisement.

Any desired metrics may be received or determined. Metrics may include, for example, the amount of time an end user views an advertisement, whether the user installs an application promoted by the advertisement, whether the user cancels display of an advertisement, whether (and at what point) a user cancels installation of an application associated with an advertisement, and other information.

Embodiments of the present disclosure may perform various post-processing steps, such as generating reports on advertising effectiveness and recalculating one or more recommendation values. As described above, once a recommendation value is initially determined, it may be used as the default value for an advertisement for any desired period of time. As the advertisement is displayed, and as metrics are collected regarding the performance (e.g., rate of successful downloads per view of an advertisement) of advertisements, cross-promotions, and other offers, such metrics may be stored in a database and used to recalculate the recommendation values for various advertisements over time.

The recommendation value can be recalculated and/or weighted based on any number of different factors, such as the performance of the advertisement (e.g. installation rate of software promoted by the advertisement), as well as based on fees paid by a publisher or advertiser to advertise its applications (also known as a “bid” from an advertiser or publisher). In some embodiments, recommendation values are weighted and ranked in order to help: provide the most relevant offer to show to an end user, maximize revenue from the advertising, provide the highest installation rate, and ensure that the frequency and/or duration that an advertisement is shown to an end user meets a minimum threshold.

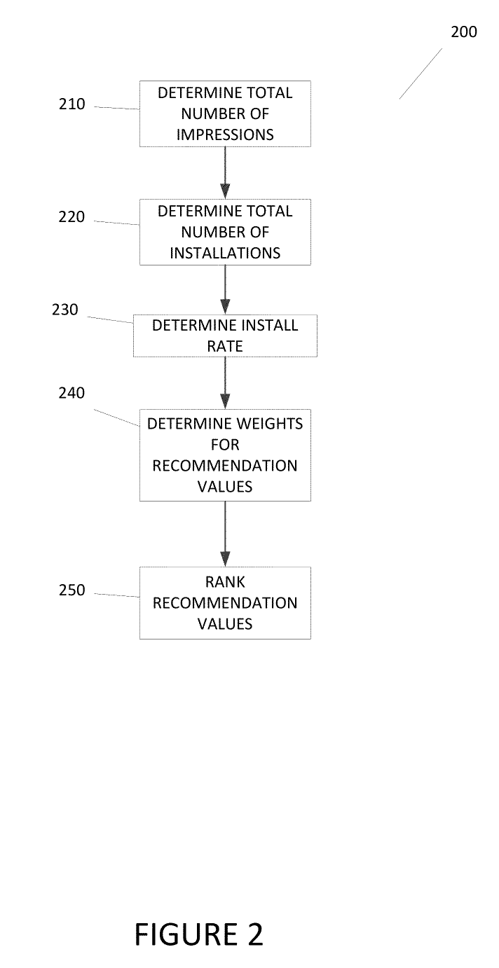

While new advertisements that have not yet been viewed can be given a default recommended value as described above, FIG. 2 illustrates and exemplary method for weighting a recommendation value given historical data on an advertisement's performance. Among other things, weighted recommendation values can be useful in determining which advertisements to provide to the client device, thus helping to enhance the performance of cross-promoting and advertising of software applications for installation to an end user, and maximizing revenue based on the actual performance of various advertisements. The exemplary method in FIG. 2 includes determining a total number of impressions (210) for an advertisement (i.e., number of views of an advertisement by and end user), determining a total number of installations for a software application promoted by the advertisement (220), determining the install rate for the advertisement (230), determining a weight for the recommendation value based on the install rate (240), and ranking recommendation values based on the determined weights (250).

Determining the total number of impressions (210), installations (220) and install rate (230) may be performed based on aggregating the information received from multiple client devices as described above, as well as from other sources. Weights for recommendation values may be determined (240) in any suitable manner, such as based on a particular geographical area or locale. In some exemplary embodiments, weights are determined using the install rate for an application in a particular locale, as well as the publisher's bid for the advertisement promoting the application in the particular locale.

An exemplary formula for calculating recommendation value weights according based on install rate and locale is as follows:

Let
L=Locale Identifier Code (For example, for en-US, L=1; for en-CA, L=2)
n=advertisement identification ID in the database
M=number of impressions for n shown
N=number of installations for n shown
t=time in days
I(n,L)=Install Rate as a function of n and L
B(n,L)=Publisher Bounty as a function of n and L
T (L)=Total Impressions Available for L
S (n,L)=Total Impressions shown for n and L
R(n,L)=Revenue for n and L
W(n,L)=Weight as a function of n and L

Then:

W(n,L)=I(n,L)×B(n,L); and

R(n,L)=S(n)×B(n,L).

In this example, W(L) may be maximized so that advertisement “n” shown in Locale “L” will result in maximum Revenue “R.” In this manner, weights for each of a plurality of advertisements can be calculated and ranked in real-time or near-real-time for any of a variety of locales as data regarding the installation rate for applications being promoted by various advertisements is collected.

Weighted recommendation values can be ranked (250) to help determine which advertisement to show to the end user. Ranking weighted recommendation values linearly, however, may not achieve the maximum revenue (“R,” above) and prevent the opportunity for all advertisements to receive impression inventory. Moreover, if the advertisement is not displayed after it's weighted recommendation value is calculated, the advertisement will have no opportunity to improve its performance or move up in the ranking. Accordingly, embodiments of the present disclosure may be configured to help ensure that all advertisements, regardless of their recommendation value, are shown to end users at least a portion of the time.

In some exemplary embodiments, weighted recommendation values may be normalized, thereby ensuring that all advertisements receive a certain number of impressions based on probability. In one such example, weighted recommendation values are first ranked in numerical order from (largest to smallest), and multiplied by an exponent of the value 10. For example: given Rank, r=3, Weight=i(n,L)×b(n,L)×10̂r=i(n,L)×b(n,L)×1000.

A probability is then calculated over the sum of the normalized weighted recommendation values to determine how many times that advertisement would be shown. All advertisements have an opportunity to be displayed in the network using this method, thereby helping to maximize revenue.

FIG. 3 shows a block diagram of system which may be used in conjunction with various embodiments. While FIG. 3 illustrates various components of a computer system, it is not intended to represent any particular architecture or manner of interconnecting the components. Other systems that have fewer or more components may also be used.

In FIG. 3, the system 300 includes a host computer system 310 comprising a processor 312, memory 314, and user interface 316. Host computer system 310 may include any number of different processors, memory components, and user interface components, and may interact with any other desired systems and devices in conjunction with embodiments of the present disclosure.

The functionality of the host system 310, including the method depicted in FIG. 1, (in whole or in part), may be implemented through the processor 312 executing computer-readable instructions stored in the memory 314 of the system 310. The memory 314 may store any computer-readable instructions and data, including software applications and embedded operating code.

The functionality of the host system 310 or other system and devices operating in conjunction with embodiments of the present disclosure may also be implemented through various hardware components storing machine-readable instructions, such as application-specific integrated circuits (ASICs), field-programmable gate arrays (FPGAs) and/or complex programmable logic devices (CPLDs). Systems according to aspects of certain embodiments may operate in conjunction with any desired combination of software and/or hardware components. The processor 312 retrieves and executes instructions stored in the memory 314 to control the operation of the system 310. Any type of processor, such as an integrated circuit microprocessor, microcontroller, and/or digital signal processor (DSP), can be used in conjunction with embodiments of the present disclosure. A memory 314 operating in conjunction with embodiments of the disclosure may include any combination of different memory storage devices, such as hard drives, random access memory (RAM), read only memory (ROM), FLASH memory, or any other type of volatile and/or nonvolatile memory. Data can be stored in the memory 314 in any desired manner.

The host system 310 includes a user interface 316 which may include any number of input devices (not shown) to receive commands, data, and other suitable input from a user, as well as any number of output devices (not shown) to provides the user with data, notifications, and other suitable information. Typical I/O devices may include mice, keyboards, modems, network interfaces, printers, scanners, video cameras and other devices.

The host system 310 may communicate with one or more client devices 320 and other systems and devices in any desired manner, including via network 330. The client device 320 may include any computing device that operates in conjunction with systems and methods of the present disclosure. The client device 820 may be, or include, a laptop computer, a desktop computer, a mobile subscriber communication device, a mobile phone, a personal digital assistant (PDA), a tablet computer, an electronic book or book reader, a digital camera, a video camera, a video game console, and/or any other suitable computing device.

The network 330 may include any electronic communications system or method. Communication among components operating in conjunction with embodiments of the present disclosure may be performed using any suitable communication method, such as, for example, a telephone network, an extranet, an intranet, the Internet, point of interaction device (point of sale device, personal digital assistant (e.g., iPhone®, Palm Pilot®, Blackberry®), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems and devices of the present disclosure may utilize TCP/IP communications protocols as well as IPX, Appletalk, IP-6, NetBIOS, OSI, any tunneling protocol (e.g. IPsec, SSH), or any number of other protocols.

Various functionality may be performed via a web browser and/or application interfacing utilizing a web browser. Such browser applications may comprise Internet browsing software installed within a computing unit or a system to perform various functions. These computing units or systems may take the form of a computer or set of computers, and any type of computing device or systems may be used, including laptops, notebooks, tablets, hand held computers, personal digital assistants, set-top boxes, workstations, computer-servers, main frame computers, mini-computers, PC servers, pervasive computers, network sets of computers, personal computers and tablet computers, such as iPads, iMACs, and MacBooks, kiosks, terminals, point of sale (POS) devices and/or terminals, televisions, or any other device capable of receiving data over a network. Various embodiments may utilize Microsoft Internet Explorer, Mozilla Firefox, Google Chrome, Apple Safari, or any other of the myriad software packages available for browsing the internet.

Various embodiments may operate in conjunction with any suitable operating system (e.g., Windows NT, 95/98/2000/CE/Mobile, OS2, UNIX, Linux, Solaris, MacOS, PalmOS, etc.) as well as various conventional support software and drivers typically associated with computers. Various embodiments may include any suitable personal computer, network computer, workstation, personal digital assistant, cellular phone, smart phone, minicomputer, mainframe or the like. Embodiments may implement security protocols, such as Secure Sockets Layer (SSL), Transport Layer Security (TLS), and Secure Shell (SSH). Embodiments may implement any desired application layer protocol, including http, https, ftp, and sftp.

Various components, modules, and/or engines may be implemented as micro-applications or micro-apps. Micro-apps are typically deployed in the context of a mobile operating system, including for example, a Palm mobile operating system, a Windows mobile operating system, an Android Operating System, Apple iOS, a Blackberry operating system and the like. The micro-app may be configured to leverage the resources of the larger operating system and associated hardware via a set of predetermined rules which govern the operations of various operating systems and hardware resources. For example, where a micro-app desires to communicate with a device or network other than the mobile device or mobile operating system, the micro-app may leverage the communication protocol of the operating system and associated device hardware under the predetermined rules of the mobile operating system. Moreover, where the micro-app desires an input from a user, the micro-app may be configured to request a response from the operating system which monitors various hardware components and then communicates a detected input from the hardware to the micro-app.

As used herein, the term “network” includes any cloud, cloud computing system or electronic communications system or method which incorporates hardware and/or software components. Communication among the parties may be accomplished through any suitable communication channels, such as, for example, a telephone network, an extranet, an intranet, the Internet, point of interaction device (point of sale device, personal digital assistant (e.g., iPhone®, Palm Pilot®, Blackberry®, Android device), cellular phone, kiosk, etc.), online communications, satellite communications, off-line communications, wireless communications, transponder communications, local area network (LAN), wide area network (WAN), virtual private network (VPN), networked or linked devices, keyboard, mouse and/or any suitable communication or data input modality. Systems may utilize TCP/IP communications protocols as well as IPX, Appletalk, IP-6, NetBIOS, OSI, any tunneling protocol (e.g. IPsec, SSH), or any number of existing or future protocols. Specific information related to the protocols, standards, and application software utilized in connection with the Internet is generally known to those skilled in the art and, as such, need not be detailed herein.

The various system components may be independently, separately or collectively suitably coupled to the network via data links which includes, for example, a connection to an Internet Service Provider (ISP) over the local loop as is typically used in connection with standard modem communication, cable modem, satellite networks, ISDN, Digital Subscriber Line (DSL), or various wireless communication methods. It is noted that the network may be implemented as other types of networks, such as an interactive television (ITV) network.

The system may be partially or fully implemented using cloud computing. “Cloud” or “Cloud computing” includes a model for enabling convenient, on-demand network access to a shared pool of configurable computing resources (e.g., networks, servers, storage, applications, and services) that can be rapidly provisioned and released with minimal management effort or service provider interaction. Cloud computing may include location-independent computing, whereby shared servers provide resources, software, and data to computers and other devices on demand.

Various embodiments may be used in conjunction with web services, utility computing, pervasive and individualized computing, security and identity solutions, autonomic computing, cloud computing, commodity computing, mobility and wireless solutions, open source, biometrics, grid computing and/or mesh computing.

Encryption may be performed by way of any of the techniques now available in the art or which may become available—e.g., Twofish, RSA, El Gamal, Schorr signature, DSA, PGP, PKI, and symmetric and asymmetric cryptosystems.

Embodiments may connect to the Internet or an intranet using standard dial-up, cable, DSL or any other Internet protocol known in the art. Transactions may pass through a firewall in order to prevent unauthorized access from users of other networks.

The computers discussed herein may provide a suitable website or other Internet-based graphical user interface which is accessible by users. For example, the Microsoft Internet Information Server (IIS), Microsoft Transaction Server (MTS), and Microsoft SQL Server, may be used in conjunction with the Microsoft operating system, Microsoft NT web server software, a Microsoft SQL Server database system, and a Microsoft Commerce Server. Additionally, components such as Access or Microsoft SQL Server, Oracle, Sybase, Informix MySQL, Interbase, etc., may be used to provide an Active Data Object (ADO) compliant database management system. In another example, an Apache web server can be used in conjunction with a Linux operating system, a MySQL database, and the Perl, PHP, and/or Python programming languages.

Any of the communications, inputs, storage, databases or displays discussed herein may be facilitated through a website having web pages. The term “web page” as it is used herein is not meant to limit the type of documents and applications that might be used to interact with the user. For example, a typical website might include, in addition to standard HTML documents, various forms, Java applets, JavaScript, active server pages (ASP), common gateway interface scripts (CGI), extensible markup language (XML), dynamic HTML, cascading style sheets (CSS), AJAX (Asynchronous Javascript And XML), helper applications, plug-ins, and the like. A server may include a web service that receives a request from a web server, the request including a URL and an IP address. The web server retrieves the appropriate web pages and sends the data or applications for the web pages to the IP address. Web services are applications that are capable of interacting with other applications over a communications means, such as the Internet.

Various embodiments may employ any desired number of methods for displaying data within a browser-based document. For example, data may be represented as standard text or within a fixed list, scrollable list, drop-down list, editable text field, fixed text field, pop-up window, and the like. Likewise, embodiments may utilize any desired number of methods for modifying data in a web page such as, for example, free text entry using a keyboard, selection of menu items, check boxes, option boxes, and the like.

The exemplary systems and methods illustrated herein may be described in terms of functional block components, screen shots, optional selections and various processing steps. It should be appreciated that such functional blocks may be realized by any number of hardware and/or software components configured to perform the specified functions. For example, the system may employ various integrated circuit components, e.g., memory elements, processing elements, logic elements, look-up tables, and the like, which may carry out a variety of functions under the control of one or more microprocessors or other control devices. Similarly, the software elements of the system may be implemented with any programming or scripting language such as C, C++, C#, Java, JavaScript, VBScript, Macromedia Cold Fusion, COBOL, Microsoft Active Server Pages, assembly, PERL, PHP, awk, Python, Visual Basic, SQL Stored Procedures, PL/SQL, any UNIX shell script, and extensible markup language (XML) with the various algorithms being implemented with any combination of data structures, objects, processes, routines or other programming elements. Further, it should be noted that the system may employ any number of conventional techniques for data transmission, signaling, data processing, network control, and the like. Still further, the system could be used to detect or prevent security issues with a client-side scripting language, such as JavaScript, VBScript or the like.

As will be appreciated by one of ordinary skill in the art, the system may be embodied as a customization of an existing system, an add-on product, a processing apparatus executing upgraded software, a stand alone system, a distributed system, a method, a data processing system, a device for data processing, and/or a computer program product. Accordingly, any portion of the system or a module may take the form of a processing apparatus executing code, an internet based embodiment, an entirely hardware embodiment, or an embodiment combining aspects of the internet, software and hardware. Furthermore, the system may take the form of a computer program product on a computer-readable storage medium having computer-readable program code means embodied in the storage medium. Any suitable computer-readable storage medium may be utilized, including hard disks, CD-ROM, optical storage devices, magnetic storage devices, and/or the like.

The system and method is described herein with reference to screen shots, block diagrams and flowchart illustrations of methods, apparatus (e.g., systems), and computer program products according to various embodiments. It will be understood that each functional block of the block diagrams and the flowchart illustrations, and combinations of functional blocks in the block diagrams and flowchart illustrations, respectively, can be implemented by computer program instructions.

These computer program instructions may be loaded onto a general purpose computer, special purpose computer, or other programmable data processing apparatus to produce a machine, such that the instructions that execute on the computer or other programmable data processing apparatus create means for implementing the functions specified in the flowchart block or blocks. These computer program instructions may also be stored in a computer-readable memory that can direct a computer or other programmable data processing apparatus to function in a particular manner, such that the instructions stored in the computer-readable memory produce an article of manufacture including instruction means which implement the function specified in the flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus provide steps for implementing the functions specified in the flowchart block or blocks.

Accordingly, functional blocks of the block diagrams and flowchart illustrations support combinations of means for performing the specified functions, combinations of steps for performing the specified functions, and program instruction means for performing the specified functions. It will also be understood that each functional block of the block diagrams and flowchart illustrations, and combinations of functional blocks in the block diagrams and flowchart illustrations, can be implemented by either special purpose hardware-based computer systems which perform the specified functions or steps, or suitable combinations of special purpose hardware and computer instructions. Further, illustrations of the process flows and the descriptions thereof may make reference to user windows, webpages, websites, web forms, prompts, etc. Practitioners will appreciate that the illustrated steps described herein may comprise in any number of configurations including the use of windows, webpages, web forms, popup windows, prompts and the like. It should be further appreciated that the multiple steps as illustrated and described may be combined into single webpages and/or windows but have been expanded for the sake of simplicity. In other cases, steps illustrated and described as single process steps may be separated into multiple webpages and/or windows but have been combined for simplicity.

The term “non-transitory” is to be understood to remove only propagating transitory signals per se from the claim scope and does not relinquish rights to all standard computer-readable media that are not only propagating transitory signals per se. Stated another way, the meaning of the term “non-transitory computer-readable medium” should be construed to exclude only those types of transitory computer-readable media which were found in In Re Nuijten to fall outside the scope of patentable subject matter under 35 U.S.C. §101.

Benefits, other advantages, and solutions to problems have been described herein with regard to specific embodiments. However, the benefits, advantages, solutions to problems, and any elements that may cause any benefit, advantage, or solution to occur or become more pronounced are not to be construed as critical, required, or essential features or elements of the disclosure.

Although the disclosure includes a method, it is contemplated that it may be embodied as computer program instructions on a tangible computer-readable carrier, such as a magnetic or optical memory or a magnetic or optical disk. All structural, chemical, and functional equivalents to the elements of the above-described exemplary embodiments that are known to those of ordinary skill in the art are expressly incorporated herein by reference and are intended to be encompassed by the present claims. Moreover, it is not necessary for a device or method to address each and every problem sought to be solved by the present disclosure, for it to be encompassed by the present claims. Furthermore, no element, component, or method step in the present disclosure is intended to be dedicated to the public regardless of whether the element, component, or method step is explicitly recited in the claims. No claim element herein is to be construed under the provisions of 35 U.S.C. 112, sixth paragraph, unless the element is expressly recited using the phrase “means for.” As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus.

Changes and modifications may be made to the disclosed embodiments without departing from the scope of the present disclosure. These and other changes or modifications are intended to be included within the scope of the present disclosure, as expressed in the following claims.

What is claimed is:

1. A computer-implemented method comprising:
receiving, by a computer system, information regarding a client computing device;
accessing a database in communication with the computer system, the database storing a plurality of advertisements promoting a respective plurality of software applications;
selecting, from the database, an advertisement from the plurality of advertisements based on the received information regarding the client device; and
providing the selected advertisement to the client computing device for display using an advertising management software application operating on the client device.

2. The method of claim 1, wherein the received information regarding the client device includes one or more of:
registry information;
operating system information;
information regarding a file stored on the client device;
a name of a software application installed on the client device;
a version of a software application installed on the client device;
a date when a software application was installed on the client device;
a date when a software application installed on the client device was last used;
a name of a software application currently in operation on the client device;
a version of a software application currently in operation on the client device;
information regarding access rights of a user of the client device;
location information for the client device;
information regarding a hardware component of the client device; and
information regarding resources of the client device.

3. The method of claim 1, further comprising redacting, from the received information, information associated with an identity of a user of the client device.

4. The method of claim 1, wherein selecting the advertisement includes selecting an advertisement promoting a software application that, based on the received information regarding client computing device, is capable of operating on the client computing device.

5. The method of claim 1, wherein selecting the advertisement includes excluding from the selection an advertisement promoting a software application that, based on the received information regarding the client computing device, is not capable of operating on the client computing device.

6. The method of claim 1, further comprising directing the advertisement management application to display the selected advertisement at one or more of a predetermined frequency and a predetermined duration.

7. The method of claim 1, further comprising:
selecting, from the plurality of advertisements in the database and based on the received information, a first advertisement and a second advertisement;
providing the first advertisement for display on the client computing device using the advertising management application for a first predetermined period of time; and
providing the second advertisement for display on the client computing device using the advertising management application for a second predetermined period of time.

8. The method of claim 7, further comprising directing the advertising management application to display the first advertisement for the first predetermined period of time and replace the first advertisement with the second advertisement after the first predetermined period of time.

9. The method of claim 1, wherein selecting the advertisement from the plurality of advertisements includes:
determining, based on the received information regarding the client device, a recommendation value for each respective software application promoted by the plurality of advertisements; and
selecting the advertisement based on the determined recommendation values.

10. The method of claim 9, wherein the recommendation value for each respective software application is determined based on one or more of:
a category to which the respective software application is classified;
a price of the respective software application; and
a size of the respective software application.

11. The method of claim 10, wherein the recommendation value for each respective software application is further determined based on one or more of:
a category to which a software application installed on the client device is classified;
a price of a software application installed on the client device; and
a size of a software application installed on the client device.

12. The method of claim 10, wherein the recommendation value for each respective software application is further determined based on one or more of:
a category to which a software application currently operating on the client device is classified;
a price of a software application currently operating on the client device; and
a size of a software application currently operating on the client device.

13. The method of claim 10, wherein the recommendation value for each respective software application is further determined based on one or more of:
a category to which a software application cross-promoted with the respective software application is classified;
a price of a software application cross-promoted with the respective software application; and
a size of a software application cross-promoted with the respective software application.

14. The method of claim 9, wherein the recommendation value for each respective software application is based at least partially on a number of installations of the respective software application and a number of views of the advertisement promoting the respective software application.

15. The method of claim 9, wherein the recommendation value for each respective software application is based at least partially on a difference in price between the respective software application and a second software application, wherein the second software application is one or more of: installed on the client device, currently operating on the client device, and cross-promoted with the respective software application.

16. The method of claim 9, wherein the recommendation value for each respective software application is based at least partially on a difference in size between the respective software application and a second software application, wherein the second software application is one or more of: installed on the client device, currently operating on the client device, and cross-promoted with the respective software application.

17. The method of claim 9, wherein the recommendation value for each respective software application is weighted based on an installation rate of the respective software application.

18. The method of claim 9, wherein the recommendation value for each respective software application is weighted based on an advertiser bid associated with each installation of the respective software application.

19. A non-transitory, computer-readable medium storing instructions that, when executed, cause a computer system to:
receive information regarding a client computing device;
access a database in communication with the computer system, the database storing a plurality of advertisements promoting a respective plurality of software applications;
select, from the database, an advertisement from the plurality of advertisements based on the received information regarding the client device; and
provide the selected advertisement to the client computing device for display using an advertising management software application operating on the client device.

20. A system comprising:
at least one processor; and
memory in communication with the at least one processor and storing instructions that, when executed by the processor, cause the system to:
receive information regarding a client computing device;
access a database in communication with the system, the database storing a plurality of advertisements promoting a respective plurality of software applications;
select, from the database, an advertisement from the plurality of advertisements based on the received information regarding the client device; and
provide the selected advertisement to the client computing device for display using an advertising management software application operating on the client device.
